(19) United States
(12) Patent Application Publication
(10) Pub. No.: US 2005/0021787 A1
(43) Pub. Date: Jan. 27, 2005

(54) System and method for permission control

(75) Inventors: Claes Kjellman, Solna (SE); Patrik Wahlstrom, Solna (SE); Michael Hedman, Sundbyberg (SE); Simon Falk, Stockholm (SE)

Correspondence Address: YOUNG & THOMPSON, 745 SOUTH 23RD STREET, 2ND FLOOR, ARLINGTON, VA, 22202, US

(73) Assignee: BLUEGRID AB, Stockholm (SE)

(21) Appl. No.: 10/494,763

(22) PCT Filed: Sep. 16, 2002
(86) PCT No.: PCT/SE02/01680

(30) Foreign Application Priority Data
Sep. 18, 2001 (SE) 0103094-9

(51) Int. Cl. G06F 15/16

(52) U.S. Cl. 709/229; 713/200

(57) ABSTRACT

A system for permission control includes transferring permission data between a user and a vendor associated with other unique identification data, in particular relating to a permission element. A user's service request is performed between a user interface and responding external issuer device. The system includes a distribution server, adapted to distribute electronic documents from the issuer to users. The server communicates with the issuer device and a communication terminal. The system comprises at least one persistent memory location, accessible from the issuer device, the distribution server and a validation unit, arranged for storage of data relating to the permission control. The validation unit is arranged between the communication terminal and an output device of the system for managing the validation of the transferred documents and permission data, managing a matching procedure between identification data and persistent information in the persistent memory, and retrieving relevant data in the persistent memory.

### TECHNICAL FIELD

The present invention relates to permission control, and more specific, to an improved system and method in particular adapted for permission control of user services.

### BACKGROUND OF THE INVENTION

There is an increased need for mobile solutions relating to user services. Practical and convenient means are mobile communication terminals.

Credit card issuers and other are of course interested in this new market area but standards and agreements have not yet been worked out. Further, solutions presented, for example the use of at least one identity associated with a SIM-card in which functions are separated, have several drawbacks as to be presented below.

Prior art concerning distribution and payment solutions using mobile terminals is disclosed at http://www.mint.se. In the system presented, a user is identified in a database by the information stored in the SIM card of the user's mobile telephone. To carry out a purchase the user makes a phone call to a managing server. If the server approves the purchase, a signal indicates approval at a terminal in the actual store. The user confirms the purchase by entering a PIN-code at the terminal, if this level of security is chosen. The purchase is registered in the managing server and a receipt is sent as a SMS (Short Message Service) or an e-mail to the user.

The system and method described are dependent of an appropriate and working telecommunication network. Such dependence today causes failures in the usage of services involving mobile solutions. Further, having several separated functions, with ditto codes or passwords, gathered in one mobile terminal, are obviously not as user friendly as many would care for.

### SUMMARY OF THE INVENTION

It is an object of the present invention to provide an improved system and method for permission control.

It is also an object of the present invention to provide a system and method that reduces the number of physical cards, keys and permission means of different kinds, with ditto codes and/or passwords. The terms refers to all kinds of electronic cards, credit or payment cards, smart cards, traveller cards, bonus cards, membership cards, access cards, season cards, library, or other, tickets, and keys, such as hotel keys etc. The object also refers to combinations of above mentioned cards and means.

Further another object of the present invention is to prevent misuse of cards, keys and/or permission means, for example season cards, such as season traveller cards.

These objects are attained by means of a system and method for permission control of at least one user to an external user service from a communication terminal, the permission control system comprising:
a bi-directionally communication between an associated user interface and a responding external issuer means;
a distribution server adapted to distribute electronic documents comprising permission data, relating to user services, to a communication terminal;
a persistent first memory location for storing permission data and other information from the electronic document, characterised in that
a validation unit is arranged between the communication terminal and an output means for extracting identification data and an electronic document from the communication terminal and associating at least one part of the electronic document with the identification data and storing the association in a memory location for subsequent cross reference whereby a result data is transmitted to the output means via the validation unit so as to control permission to interacting user services.

It is another object of the present invention to provide a system and method, which decrease the time necessary to complete a transaction such as purchase payments. The extraction of unique identification data, for example IMEI (International Mobile Equipment Identity), SIMID (Subscriber.Identity Module Identity), MSISDN (Mobile Station Integrated Services Digital Network), IMSI (International Mobile Subscriber Identity), ICCID (Integrated Circuit Card Identifier) from a user's communication terminal and thereafter followed validation procedure takes less time than to make a phone call for validation as described for related art. Thus, check out lines at for example stores may be shortened.

The present invention provides a more user-friendly system than systems obtainable presently. The user does not need to know the actual unique identification data. A simple activation of the communication link is sufficient. Further, no dependencies of a working, adequate and available telephone network, as required for related art, is present. Furthermore, the invention obviously provides an alternative to cash, and users may feel more comfortable carrying less cash with them.

Misuse, of for example season cards, are prevented basically because users are less willing to lend their communication terminals, i.e. mobile telephones, than a plastic card, to unauthorised users. The invention diminishes mentioned misuse by this improved identification method, which preferably includes verification using PIN-codes. Thus, companies having personnel using, for example, season traveller cards, will get a better control over how their issued cards are used. Invoices may consequently be more precise and correctly addressed.

Other effects of the invention, which provides a system and method for improved service, may consequently be improved cash records for vendors nevertheless the picture of purchase habits and patterns. This is of course beneficial for vendors, who also may use adapted simple and fast communication means, such as SMS, EMS, (Enhanced Message Service), MMS (Multimedia Messaging Service), e-mail, etc to inform and communicate with users. Last, but not at all least, mentioned benefits hopefully result in lower prices for the end customers.

Additional objects, advantages and novel features of the present invention will become apparent to those skilled in the art from the following details, as well as by practice of the invention. While the invention is described below, it should be understood that the invention is not limited to that. The above mentioned sildled persons having access to the teachings herein will recognise additional applications, modifications and embodiments in other fields which are within the scope of the invention.

### BRIEF DESCRIPTIONS OF THE INVENTION

For a more complete understanding of the present invention and further objects and advantages thereof, reference is now made to the following description of examples—as shown in the accompanying drawings, in which:

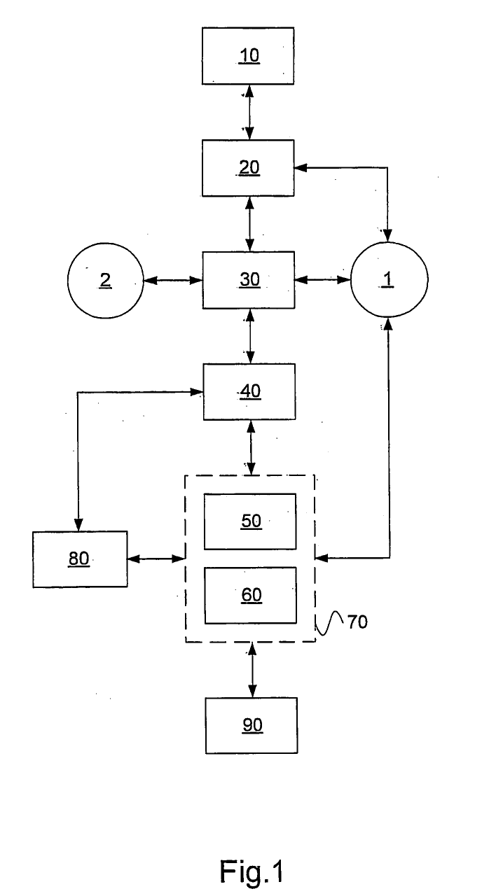

FIG. 1 illustrates a schematic survey of an improved system for permission control in accordance with the present invention.

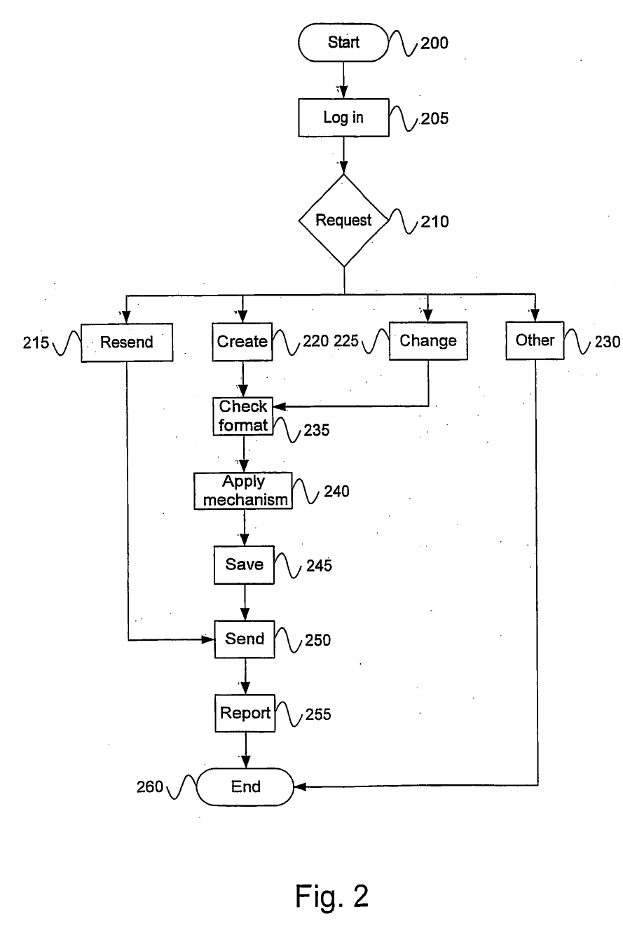

FIG. 2 illustrates a flowchart representing the method of a distribution server 30 in accordance with the present invention.

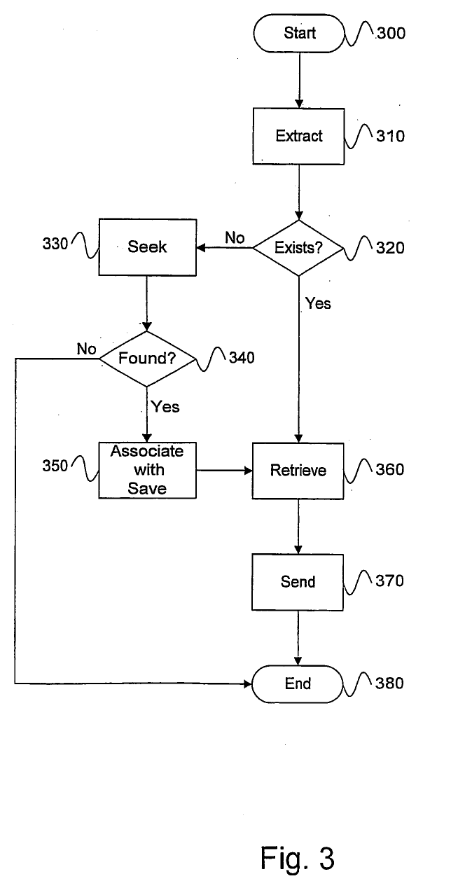

FIG. 3 illustrates a schematic flowchart of a validation host 50 in accordance with the present invention.

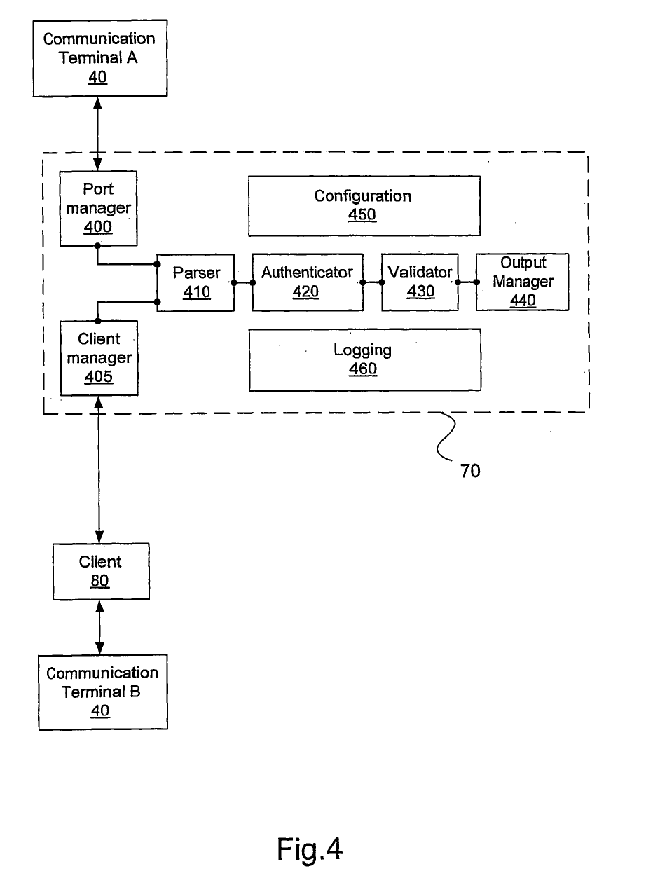

FIG. 4 illustrates a schematic block representation survey of a validation host 70 in accordance with the present invention.

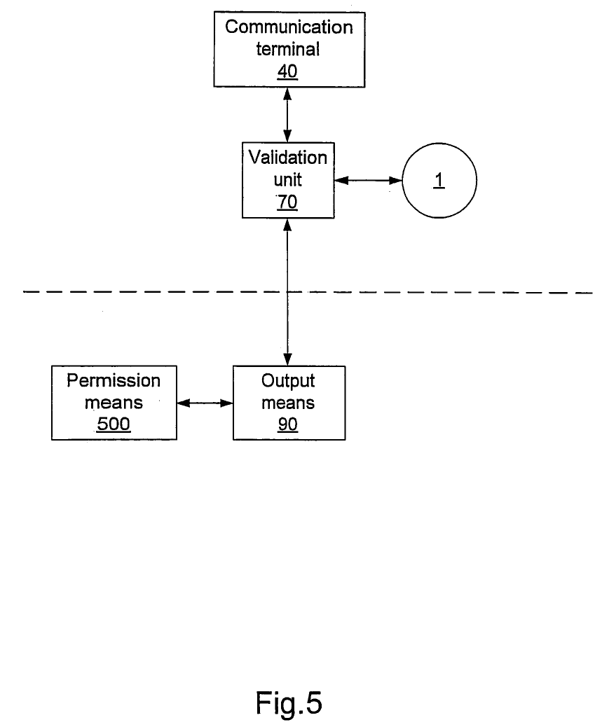

FIG. 5 illustrates an example of an application of the present invention is adapted to work parallel with already existing permission systems.

### DETAILED DESCRIPTION OF EMBODIMENTS

FIG. 1 shows the general structure of a system for permission control, which consists of a user interface 10 that communicates with an issuer means 20. The user interface consists of either a WAP-browser (Wireless Application Protocol), Web-browser, computer telephone integration (CTI), call-centre, CRM-system (Customer Relation Management), or other.

The issuer means 20 is connected to a first database 1 by which information can be transmitted; further relevant data, such as permission data, can be sent and stored in the first database 1. The issuer means is further adapted to communicate with a distribution server 30.

The distribution server 30 manages the communication with a communication terminal 40, which may be a mobile communication terminal or other, via a network media, e.g. a telecom network or the Internet, using SMS, MMS, e-mail or other as a carrier. The distribution server 30 distributes for example electronic documents to the communication terminal 40. The documents comprise relevant information for an activation of a service and, further, information meant to be stored in the first database 1. Furthermore, the distribution server 30 is connected to a second database 2 in which logging information among other is stored.

The communication terminal 40 is adapted to communicate with a validation client 80 and a validation unit 70, using for example infrared technology (IR) or radio frequency (RF) technology, e.g. Bluetooth.

The validation unit 70 comprises a hardware module 60, for example a PC, hand held device, or other, and software which from now on is referred to as validation host 50. The validation client 80 comprises a port manager. The validation unit 70 is connected to the first database 1. The validation unit 70 is also adapted to communicating with the output means 90, such as communication ports, data capture hubs, GUI, printers, monitors, turnstiles, touch screens, or other. Further, the output means 90 is adopted to communicate with an already existing service, such as a payment service, the principle is shown in FIG. 5.

FIG. 2 systematically illustrates a flowchart representing a method for distribution, e.g. a flowchart representation of the procedures carried out by a software in the distribution server 30 shown in FIG. 1. The issuer means 20 can communicate with the distribution server 30 using, for example, H=T-POST, HTTP-GET, Socket, SSL, SMTP or other. The issuer means 20 initiates an electronic document preferably formatted using XML, but other data formats may of course be employed.

After start 200, a first method step log in 205, with registration of the current user, is performed. If registration is completed and approved, the issuer means 20, as shown in FIG. 1, is sending a request 210 to the distribution server 30. There are at least four different options from which the issuer means 20 can choose.

The first option is to create an electronic document 220 comprising permission data.

Consequently, data is validity checked and formatted 235. If data is approved, one or several security mechanisms can be applied 240, for example, encipherment, digital signature, access control, data integrity, authentication exchange, notarisation, or other.

Encipherment fulfils the service confidentiality and partly authentication and integrity. This can be performed with either a symmetric (the same key is used for both coding and decoding) or asymmetric (different keys are used) algorithm. Further, the algorithm can be either a block cipher or a stream cipher depending on how it acts on the message.

The preferred security mechanism in the present invention is digital signature. The term refers to an encrypted check-sum of an electronic document or message. Each issuer of signatures has a unique pair of keys from which one is private and the other is public. The public key is available for anyone who needs to verify the signature. The private key is used for signing, and the public key is used for verification of the signatures created by the private key.

Access control implies a connection between the identity of a subject and one or several authorities, i.e. powers and competencies to objects or events. The first step in an access control is to verify the purchaser's identity. Significant for this security mechanism is an access control database with information about the purchaser.

The security mechanism data integrity guarantees the receiver that transmitted data is neither intentionally nor non-intentionally changed during the transmission, and is based upon a checksum calculation or a cryptographic control value.

Authentication exchange is a security mechanism for either one or two way verification of the counter-part's identity. In the simplest case, this can be performed with passwords.

Notarisation means that transmission attribute information is entrusted to a third part, for later verification.

A copy of the electronic document created in step 220 is then saved (in step 245) in a persistent storage, i.e. in the database 2. The electronic document is thereafter sent (in step 250) to the communication terminal 40 in FIG. 1, and a report is sent 255 to the issuer means 20 which reports consist of results and status of distribution request. The routine ends at step 260.

The second request option is to re-send, in step 215, an already existing electronic document. The procedure precedes step 250, 255 and 260.

The third request option is to change, in step 225, one or more parameters in an already existing electronic document. Thereafter the steps 235-260 are performed.

The fourth request option is any other 230 option, such as, statistics and/or status information, etc. One or more steps between the steps 215 and 265 may be performed.

FIG. 3 illustrates a schematic flowchart of the validation host 50. First, at least one unique identification data, such as IMEI, is extracted 310 from the communication terminal 40 by either the port manager in the client 80 or by the port manager 400 in the validation host 70, refer to FIGS. 1 and 4. The validation host checks in the database 1 if the unique identification data already exists 320, i.e. if the user is registered:

If not, the validation host seeks 330, i.e. extracts and identifies an electronic activation document from the communication terminal 40. The result of the search is indicated in 340. Whether an electronic activation document is found, the permission data contained therein is associated with the corresponding unique identification data and saved 350 in the first database 1. Thereafter the step 360 is carried out. If an activation document is not found, the routine ends 380.

If so, i.e. the unique identification data already exists in the first database 1, permission data is retrieved 360 and sent 370, possibly together with a result signal, to the output means 90, as referred to in FIG. 5. Thereafter the routine ends 380.

FIG. 4 illustrates a block representation of the software in the validation unit 70 in FIG. 1, comprising the following: A port manager 400, a client manager 405 followed by a parser 410 and an authenticator 420. Furthermore, a validator 430 and an output manager 440. The validation host 70 also comprises configuration methods 450 and logging routines 460. Further, FIG. 4 also illustrates that a communication terminal A which is adapted to communicate with the port manager 400, and a communication terminal B which is adapted to communicate with a port manager located in a client 80. The validation client 80 communicates with the client manager 405. Both the communication terminals A and B are referred to as the communication terminal 40 in FIG. 1. The notation A and B simply refers to where the extraction is performed, at the validation unit 70, or at the validation client 80.

Consider an application of the present invention where a user, by following procedures shown in FIG. 1, e.g. interacting with the issuer means 20, receives an electronic (activation) document through the distribution server 30 to his communication terminal 40. The user has to pass through the sequence of validation, described with reference to FIG. 3, to get permission to an event, such as to complete a purchase or pass a check point.

The embodiment comprises situations in which it is of major importance to be able to upgrade and exchange software in a convenient, fast and cost-effective manner. This embodiment with clients handled by a central server meets such requirements, not the least for maintenance and service reasons. The central server may be for instance a PC, with a plurality of associated validation clients 80. By using a number of communication terminals 40 for communication with the validation clients 80 as shown in FIG. 4, for example hand held devices that communicate directly with the client manager 405 in the validation host 50 in the validation unit 70, shown in FIG. 1, the object of enabling flexible software upgrades and convenient maintenance of the system is fulfilled.

At the time for validation the user seeks out a validation client 80 which is adapted to communicate with the validation unit 70. The validation client 80 comprises a port manager, which extracts the unique identification data(s) and/or electronic documents from the user's communication terminal 40 and sends it to a validation unit 70 for validation. The communication between the client 80 and the user's communication terminal 40 is preferably executed by using infrared (IR) technology or radio fiequency (RF) technology, e.g. Bluetooth. However, other methods for access may evolve freely within the general field of transmission technologies. The communication between the validation client 80 and the validation unit 70 is preferable carried out using wireless local area networks (WLANs).

The extracted electronic documents are handled and processed in the validation unit 70, as described below, and a response is sent back from the validation unit 70 to the validation client 80. The response includes one of the following: Firstly, status information of electronic documents and permission data. Secondly, the response announces in case no electronic documents and permission data were found and third, any other error code or information.

It can easily be understood that this embodiment of the invention centralises the validation to a limited number of validation units 70, often a single one is sufficient. Consequently, many clients may contribute to that permission accesses are accomplished fast.

The client manager 405 manages the network communication between the validation client 80 and the validation unit 70. Client manager 405 is de facto a server and reads electronic documents and unique identification data sent from the validation client 80.

Electronic documents are translated to an internal data format, for example in the SMS case, from PDU (Protocol Data Unit), in the parser 410. Electronic documents written in a not suitable or desired format are filtered off and remaining electronic documents are compared with a template. Further, controls of date, time, etc., are effected.

In authenticator 420 an authentication of the electronic document is carried out. Depending on which security mechanisms that were applied in step 240, refer to FIG. 2, this is performed in different ways.

The next step is to validate the permission data. This is accomplished by verification towards the first database 1, and is carried out by the validator 430.

After validation, the results are sent back to the validation client 80, as earlier mentioned, and in some cases managed by an output manager 440. The results might be presented or applicable to various forms of outputs in the output means 90, shown in FIG. 1. For example, communication ports, data capture hubs, monitors, graphical user interfaces (GUIs), gates, turnstiles, printers, touch screens etc. The output manager 440 can be tailored, i.e. individually adapted, to the actual technical infrastructure at a vendor.

FIG. 5 illustrates how three parts from the general system, i.e. the communication terminal 40, the validation unit 70 and the database 1, shown in FIG. 1, of the present invention, may work in one application. The validation unit 70 is connected to the output means 90, which is interacting with permission means 500, as a parallel function.

The output means 90, for example a cash register, is connected to permission means 500; for example a credit card reader. This is simply an alternative payment system and method to already existing systems and methods.

This shows the strength in the invention. With a simple connection between the validation unit 70 and an already existing output means 90, the system and method of the present invention is working in parallel with related technology, but improved and made more accessible faster and more efficient.

1. A system for permission control of at least one user to an external user service from a communication terminal (40), the permission control system comprising:
a bi-directionally communication between an associated user interface (10) and a responding external issuer means (20); a distribution server (30) adapted to distribute electronic documents comprising permission data, relating to user services, to a communication terminal (40);
a persistent first memory location (1) for storing permission data and other information from the electronic document;
wherein
the validation unit (70) is arranged between the communication terminal (40) and an output means (90) for extracting identification data and an electronic document from the communication terminal (40) and associating at least one part of the electronic document with the identification data and storing the association in the first memory location (1) for subsequent cross reference whereby a result data is transmitted to the output means (90) via the validation unit (70) so as to control permission to interacting user services.

2. A system for permission control according to claim 1, wherein:
the communication terminal (40) is a mobile unit, such as a mobile telephone, personal digital assistant (PDA), a pager or any other kind of electronic communication means.

3. A system for permission control according to claim 1, wherein:
communication between the distribution server (30) and the communication terminal (40) is accomplished by means of anyone of the following message carriers or notification services: SMS (Short Message Service), MMS (Multimedia Messaging Service), EMS (Enhanced Message Service) or electronic mail.

4. A system for permission control according to claim 1, wherein:
the validation unit (70) is provided with a client manager (405) for handling a plurality of validating clients (80) simultaneously.

5. A system for permission control according to claim 1, wherein:
the validation unit (70) is provided with a port manager (400) for centralised handling of a plurality of validations of documents.

6. A system for permission control according to claim 1, wherein:
the validation unit (70) is provided with a combination of client manager (405) and port manager (400).

7. A system for permission control according to claim 1, wherein:
the communication between the communication terminal (40) and the validation unit (70), directly or via the validation client (80), is performed by means of radio frequency technology, infrared transmission or another state of the art transmission technology.

8. A system for permission control according to claim 1, wherein:
the user services includes at least one of the following; transaction, payment or permission service, comprising components such as automatic cash dispensing machines, cash registers and/or gate controls.

9. A system for permission control according to claim 1, wherein:
the permission data comprises relevant data to the user service such as bank, payment and credit card numbers, personal code numbers and membership numbers.

10. A system for permission control according claim 1, wherein:
the unique identification data is data associated with the communication terminal (40), such as IMEI (International Mobile Equipment Identity), SIMID (Subscriber Identity Module Identity), MSISDN (Mobile Station Integrated Services Digital Network) and IMSI (International Mobile Subscriber Identity).

11. A method for controlling at least one user's ability to access an external user service from a communication terminal (40), applicable when unique identification data and permission data relating to the user and the user service, respectively, are stored in a first database (1), the method comprising the steps of:
extracting by means of a central validation unit (70) unique identification data from the communication terminal (40);
transmitting the unique identification data from the central validation unit (70) to the connected first database (1);
comparing the transmitted unique identification data with present identification data stored in the first database (1) for obtaining a validity result;
transmitting the validity result and associated permission data from the first database (1) to the external user service, the result transmitted via the validation unit (70); and
depending on the validity result, enabling user access to services hosted by the external user service, via an output means (90) associated with the validation unit (70).

12. A method for controlling permission according to claim 11, applicable when identification data relating to the user is not yet stored in a first database (1), the method comprising the steps of:
the user connecting to an external issuer means (20) via a user interface (10);
the external issuer means (20) transmitting permission data to a connected distribution server (30);
the distribution server (30) applying a security mechanism to an electronic document comprising permission data followed by transmission of said document from the distribution server (30) to the user's communication terminal (40) for subsequent storage of an association of unique identification data and permission data in the first database (1) at the time of validation.

13. A method for controlling permission according to claim 12, further comprising the step of:
applying at least one security mechanism (240) in order to enable later authentication of the electronic document.

14. A method for controlling permission according to claim 12, comprising the step of
transmitting from the external issuer means (20), as a minimum, identification data directly to the first database (1).

15. A method for permission control according to claim 11, wherein:
the validation unit (70) transmitting result data back to the validation client (80) in response to the electronic document and/or the unique identification data originally sent from the validation client (80).

16. A method for permission control according to claim 11, wherein:
the validation unit (70) transmitting result data to the output means (90) in response to the electronic and/or the unique identification data extracted and validated by the validation host (50).

17. A method for permission control according to claim 11, wherein:
the validation unit (70) transmitting result data back to the validation client (80) and to the output means (90) in response to the electronic document and/or the unique identification data originally sent from the client, separately and at the same time.

18. A method for permission control according to anyone of claims method for permission control according to claim 11, further comprising the steps of:
initialising software update of the validation client (80) by means of the validation client (80) automatically requesting a software update from the validation unit (70)
transmitting a new software from the validation unit (70) to the validation client (80)
the validation client (80) replacing the old software with the new software
the validation client (80) retrieving new parameters from the validation unit (70).

19. A computer program product containing instructions executable by a computer for permission control of user services, the computer program product being adapted for initialising and carrying out the method steps of claim 11.

20. A computer program product containing instructions executable by a computer for permission control of user services, the computer program product being adapted for initialising and carrying out the method steps of claim 12.
